(19) United States
(12) Patent Application Publication
(10) Pub. No.: US 2011/0235216 A1
(43) Pub. Date: Sep. 29, 2011

(54) LONGITUDINAL BIAS STACK FOR A CURRENT-PERPENDICULAR-TO-PLANE (CPP) READ SENSOR

(76) Inventor: Tsann Lin, Saratoga, CA (US)

(21) Appl. No.: 12/748,199

(22) Filed: Mar. 26, 2010

(51) Int. Cl. G11B 5/127; G11B 5/39

(52) U.S. Cl. 360/324; 29/603.08

(57) ABSTRACT

A read head having an improved longitudinal bias stack for stabilizing the sense layer structure of a CPP read sensor is proposed. The longitudinal bias stack is separated by an insulation layer from the CPP read sensor in each of two side regions, and is sandwiched together with the insulation layer and the CPP read sensor between lower and upper ferromagnetic shields in the read head. In a preferred embodiment of the invention, the longitudinal bias stack mainly comprises an Fe—Pt longitudinal bias layer without any seed layers, and thus the thickness of the insulation layer alone defines a spacing between the Fe—Pt longitudinal bias layer and the CPP read sensor. Since the Fe—Pt longitudinal bias layer without any seed layers exhibits good in-plane hard-magnetic properties after annealing and the spacing is narrow, the stabilization scheme is effective.

### FIELD OF THE INVENTION

The invention relates to an improved longitudinal bias stack for stabilizing the sense-layer structure of a current-perpendicular-to-plane (CPP) tunneling magnetoresistance (TMR) or giant magnetoresistance (GMR) read sensor in a read head.

### BACKGROUND OF THE INVENTION

One of many extensively used non-volatile storage devices is a magnetic disk drive. The magnetic disk drive includes a rotatable magnetic disk and an assembly of write and read heads. The assembly of write and read heads is supported by a slider that is mounted on a suspension arm. The suspension arm is supported by an actuator that can swing the suspension arm to place the slider with its air bearing surface (ABS) over the surface of the magnetic disk.

When the magnetic disk rotates, an air flow generated by the rotation of the magnetic disk causes the slider to fly on a cushion of air at a very low elevation (fly height) over the magnetic disk. When the slider rides on the air, the actuator moves the suspension arm to position the assembly of the write and read heads over selected data tracks on the magnetic disk. The write and read heads read and write data on the magnetic disk. Processing circuitry connected to the assembly of the write and read heads then operates according to a computer program to implement writing and reading functions.

The write head includes a magnetic write pole and a magnetic return pole, which are magnetically connected with each other at a region away from the ABS, and are surrounded by an electrically conductive write coil. In a writing process, the electrically conductive write coil induces a magnetic flux in the write and return poles. This results in a magnetic write field that is emitted from the write pole to the magnetic disk in a direction perpendicular to the surface of the magnetic disk. The magnetic write field writes data on the magnetic disk, and then returns to the return pole so that it will not erase previously written data tracks.

The read head includes a read sensor which is electrically separated by insulation layers from longitudinal bias stacks in two side regions, but electrically connected with lower and upper ferromagnetic shields. In a reading process, the read head passes over magnetic transitions of a data track on the magnetic disk, and magnetic fields emitting from the magnetic transitions modulate the resistance of the read sensor in the read head. Changes in the resistance of the read sensor are detected by a sense current passing through the read sensor, and are then converted into voltage changes that generate read signals. The resulting read signals are used to decode data encoded in the magnetic transitions of the data track.

A current-perpendicular-to-plane (CPP) tunneling magnetoresistance (TMR) or giant magnetoresistance (GMR) read sensor is typically used in the read head. The CPP TMR read sensor includes a nonmagnetic insulating barrier layer sandwiched between lower and upper sensor stacks, while the CPP GMR read sensor includes a nonmagnetic conducting spacer layer sandwiched between the lower and upper sensor stacks. The thickness of the barrier or spacer layer is selected to be less than the mean free path of conduction electrons passing through the CPP GMR or GMR read sensor. The lower sensor stack comprises a buffer layer, a seed layer, a pinning layer, a keeper layer structure, an antiparallel-coupling layer, and a reference layer structure, while the upper sensor stack comprises a sense layer structure and a cap layer. The keeper layer structure, the antiparallel-coupling layer, and the reference layer structure form a flux closure, where antiparallel coupling occurring across the antiparallel-coupling layer orients the magnetizations of the keeper and reference layer structures in opposite transverse directions, one away from and the other towards the ABS. On the other hand, the reference layer structure, the barrier or spacer layer, and the sense layer structure form a scattering zone, where ferromagnetic coupling occurring across the barrier or spacer layer counter-balances demagnetizing stemming from the flux closure, resulting in the orientation of the magnetizations of the sense layer structure in a longitudinal direction parallel to the ABS.

When passing a sense current through the CPP TMR or GMR read sensor, conduction electrons are scattered at lower and upper interfaces of the barrier or spacer layer. When receiving magnetic fields emitting from the magnetic transitions on the magnetic disk, the magnetization of the reference layer structure remains pinned while that of the sense layer structure rotates. Scattering decreases as the magnetization of the sense layer structure rotates towards that of the reference layer structure, but increases as the magnetization of the sense layer structure rotates away from that of the reference layer structure. These scattering variations lead to changes in the resistance of the CPP TMR or GMR read sensor in proportion to the magnitudes of the magnetic fields, or to cos θ, where θ is an angle between the magnetizations of the reference and sense layer structures. The changes in the resistance of the CPP TMR or GMR read sensor are then detected by the sense current and converted into voltage changes that are detected and processed as playback signals.

In order for the magnetization of the sense layer structure to rotate stably in the reading process, the longitudinal bias stack is used at two tails of the sense layer structure to induce magnetostatic interactions across the sense layer structure. The longitudinal bias stack typically comprises a seed layer, a longitudinal bias layer, and a cap layer. The longitudinal bias layer must exhibit a remnant moment (M_{R} δ_{LB}, where M_{R} is its remnant magnetization and δ_{LB} is its thickness) high enough to prevent reversals of the magnetization of the sense layer structure after various magnetic excitations through balancing of net charges at the two tails of the sense layer structure, and a coercivity (H_{C}) high enough to pin the magnetization of the sense layer structure through magnetostatic interactions across the sense layer structure. This stabilization scheme is currently effective in stabilizing a sense layer structure with a saturation moment of 0.42 memu/cm² (corresponding to that of a 6 nm thick ferromagnetic 80Ni-20Fe films sandwiched into two Cu films) in a read head with a width of 50 nm, but require improvements as the read head is progressively miniaturized for magnetic recording at higher recording densities.

### SUMMARY OF THE INVENTION

The invention provides an improved longitudinal bias stack for stabilizing the sense-layer structure of a current-perpendicular-to-plane (CPP) tunneling magnetoresistance (TMR) or giant magnetoresistance (GMR) read sensor in a read head. The longitudinal bias stack is separated by an Al₂O₃ insulation layer from the CPP read sensor in each of two side regions, and is sandwiched together with the Al₂O₃ insulation layer and the CPP read sensor between lower and upper ferromagnetic shields in the read head.

In a preferred embodiment of the invention, the longitudinal bias stack mainly comprises an Fe—Pt longitudinal bias layer without any seed layers, and thus the thickness of the Al₂O₃ insulation layer, instead of the total thicknesses of the Al₂O₃ insulation and seed layers used in a prior art, defines a spacing between the longitudinal bias layer and the CPP read sensor. Since the Fe—Pt longitudinal bias layer without any seed layers exhibits good in-plane hard-magnetic properties after annealing and the spacing is narrow, the stabilization scheme is effective.

In an alternative embodiment of the invention, the longitudinal bias stack mainly comprises the Fe—Pt longitudinal bias layer with an insulating MgO seed layer that replaces a portion of the Al₂O₃ insulation layer. Since the Fe—Pt longitudinal bias layer with the MgO seed layer exhibits better in-plane hard-magnetic properties after annealing and the spacing remains narrow, the stabilization scheme is more effective.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a magnetic disk drive in which the invention is embodied;

FIG. 2 is an ABS schematic view of a read head in accordance with a prior art;

FIG. 3 is a graph showing easy-axis magnetic responses of as-deposited 82Co-18Pt(24)/Cr(10), Cr(4)/82Co-18Pt(24)/Cr(10) and 80Cr-20Mo(4)/82Co-18Pt(24)/Cr(10) films;

FIG. 4 is a graph showing easy-axis magnetic responses of 82Co-18Pt(24)/Cr(10), Cr(4)/82Co-18Pt(24)/Cr(10) and 80Cr-20Mo(4)/82Co-18Pt(24)/Cr(10) films after annealing for 5 hours at 280° C.;

FIG. 5 is a graph showing H_{C} versus the seed layer thickness (δ_{S}) for Cr/82Co-18Pt(24)/Cr(10) and 80Cr-20Mo/82Co-18Pt(24)/Cr(10) films before and after annealing for 5 hours at 280° C.;

FIG. 6 is a schematic ABS view of a read head in accordance with a preferred embodiment of the invention;

FIG. 7 is a graph showing easy-axis responses of as-deposited Fe—Pt(24) films;

FIG. 8 is a graph showing easy-axis responses of Fe—Pt(24) films after annealing for 5 hours at 280° C.;

FIG. 9 is a graph showing H_{C} versus the Pt content for the Fe—Pt film before and after annealing for 5 hours at 280° C.;

FIG. 10 is a graph showing x-ray diffraction patterns taken from 53.2 Fe-46.8Pt films before and after annealing for 5 hours at 280° C.;

FIG. 11 is a schematic ABS view of a read head in accordance with an alternative embodiment of the invention.

FIG. 12 is a graph showing easy-axis responses of as-deposited Fe—Pt(20), MgO(1.6)/Fe—Pt(20) and MgO (1.6)/Ru(1.8)/Fe—Pt(20) films;

FIG. 13 is a graph showing easy-axis responses of Fe—Pt(20), MgO(1.6)/Fe—Pt(20) and MgO(1.6)/Ru(1.8)/Fe—Pt(20) films annealing for 5 hours at 280° C.;

FIG. 14 is a graph showing H_{C} versus the seed-layer thickness of MgO/Fe—Pt(20), MgO(1.6)/Ru/Fe—Pt(2), MgO(1.6)/Rh/Fe—Pt(2) and MgO(1.6)/Pt/Fe—Pt(2) films; and

FIG. 15 is a graph showing H_{C} versus the Fe—Pt film thickness for Fe—Pt and MgO(1.6)/Fe—Pt films.

### DETAILED DESCRIPTION OF THE EMBODIMENTS

The following description is of the best embodiments presently contemplated for carrying out this invention. This description is made for the purpose of illustrating the general principles of this invention and is not meant to limit the inventive concepts claimed herein.

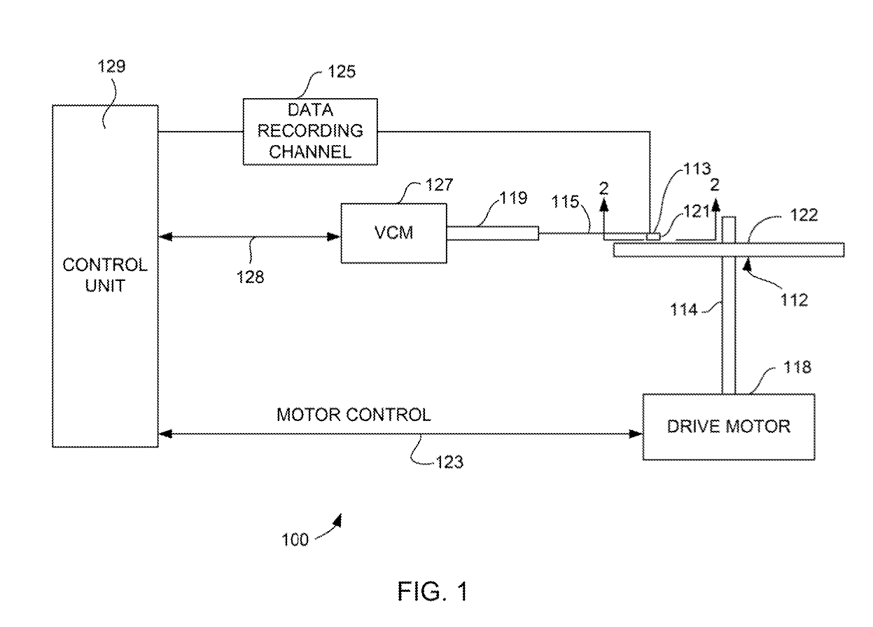

Referring now to FIG. 1, there is shown a magnetic disk drive 100 embodying the invention. As shown in FIG. 1, at least one rotatable magnetic disk 112 is supported on a spindle 114 and rotated by a disk drive motor 118. Magnetic recording on each magnetic disk is performed at annular patterns of concentric data tracks (not shown) on the magnetic disk 112.

At least one slider 113 is positioned near the magnetic disk 112, each slider 113 supporting one assembly of write and read heads 121. As the magnetic disk 112 rotates, the slider 113 moves radially in and out over the disk surface 122 so that the assembly of write and read heads 121 may access different data tracks on the magnetic disk 112. Each slider 113 is mounted on a suspension arm 115 that is supported by an actuator 119. The suspension arm 115 provides a slight spring force which biases the slider 113 against the disk surface 122. Each actuator 119 is attached to an actuator means 127 that may be a voice coil motor (VCM). The VCM comprises a coil movable within a fixed magnetic field, the direction and speed of the coil movements being controlled by the motor current signals supplied by controller 129.

During operation of the magnetic disk drive 100, the rotation of the magnetic disk 112 generates an air bearing between the slider 113 and the disk surface 122 which exerts an upward force or lift on the slider 113. The air bearing thus counter-balances the slight spring force of the suspension arm 115 and supports the slider 113 off and slightly above the disk surface 122 by a small, substantially constant spacing during sensor operation.

The various components of the magnetic disk drive 100 are controlled in operation by control signals generated by the control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position the slider 113 to the desired data track on the magnetic disk 112. Write and read signals are communicated to and from the assembly of write and read heads 121 by way of the recording channel 125.

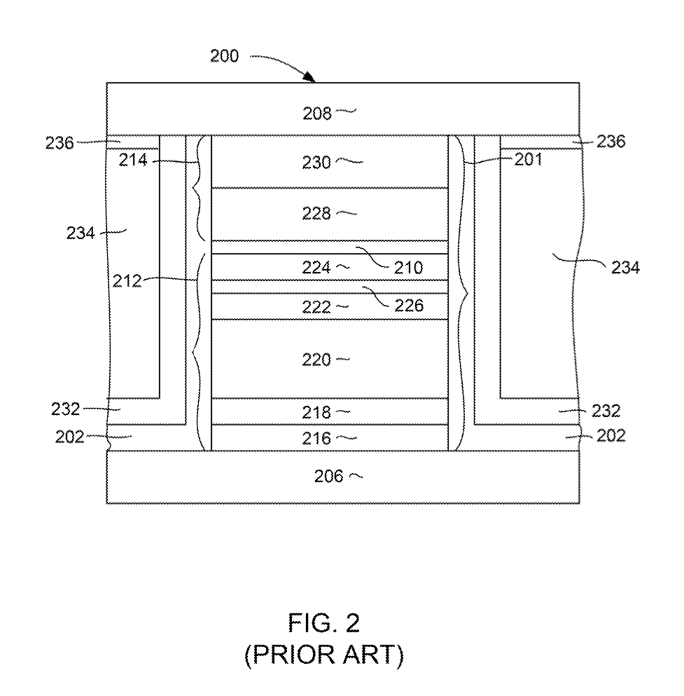

In a typical read head 200, as shown in FIG. 2, a current-perpendicular-to-plane (CPP) tunneling magnetoresistanee (TMR) or giant magnetoresistance (GMR) read sensor 201 is electrically insulated by insulation layers 202 from longitudinal bias stacks 204 in two side regions for preventing a sense current from shunting through the two side regions, but is electrically connected with lower and upper ferromagnetic shields 206, 208 for allowing the sense current to flow in a direction perpendicular to planes of the CPP TMR or GMR read sensor 201.

A typical CPP TMR read sensor 201 includes an electrically insulating barrier layer 210 sandwiched between lower and upper sensor stacks 212, 214. The barrier layer 210 is formed of a nonmagnetic oxygen-doped Mg (Mg—O), Mg oxide (MgO), or Mg—O/MgO/Mg—O (MgOₓ) film having a thickness ranging from 0.4 to 1 nm. When the sense current quantum-jumps across the Mg—O, MgO or MgOₓ barrier layer 210, changes in the resistance of the CPP TMR read sensor 201 are detected through a TMR effect.

A typical CPP GMR read sensor 201 includes an electrically conducting spacer layer 210 sandwiched between lower and upper sensor stacks 212, 214. The spacer layer 210 is formed of a nonmagnetic Cu or oxygen-doped Cu (Cu—O) film having a thickness ranging from 1.6 to 4 nm. When the sense current flows across the Cu or Cu—O spacer layer 210, changes in the resistance of the CPP GMR read sensor is detected through a GMR effect.

The lower sensor stack 212 comprises a buffer layer 216 formed of a 2 nm thick nonmagnetic Ta film, a seed layer 218 formed of a 2 nm thick nonmagnetic Ru film, a pinning layer 220 formed of a 6 nm thick antiferromagnetic 23.2Ir-76.8Mn film (composition in atomic percent), a keeper layer structure 222, an antiparallel-coupling layer 226 formed of a 0.8 nm thick nonmagnetic Ru film, and a reference layer structure 224. The keeper layer structure 222 comprises a first keeper layer formed of a 1.6 nm thick 72.5Co-27.5Fe film and a second keeper layer formed of a 0.6 nm thick 64.1Co-35.9Fe film. The thickness of the keeper layer structure 222 is selected in order to attain a saturation moment of 0.32 memu/cm² (corresponding to that of 4.6 nm thick ferromagnetic 80Ni-20Fe films sandwiched into two Cu films). The reference layer structure 224 comprises a first reference layer formed of a 0.6 nm thick 64.1Co-35.9Fc film, a second reference layer formed of a 0.6 nm thick 75.5Co-24.5Hf film, a third reference layer formed of a 1.2 nm thick 65.5Co-19.9 Fe-14.6 B film, and a fourth reference layer formed of a 0.3 nm thick 46.8Co-53.2 Fe film. The thickness of the reference layer structure 224 is selected in order to attain a saturation moment of 0.30 memu/cm² (corresponding to that of 4.3 nm thick ferromagnetic 80Ni-20Fe films sandwiched into two Cu films).

The upper sensor stack 214 comprises a sense layer structure 228 and a cap layer 230 formed of a 6 nm thick nonmagnetic Ru film. The sense layer structure 228 comprises a first sense layer formed of a 0.4 nm thick ferromagnetic 87.5Co-12.5Fe film, a second sense layer formed of a 1.6 nm thick ferromagnetic 1.6 nm 79.3Co-4.0Fe-16.713 film, and a third sense layer formed of a 2.8 nm thick ferromagnetic 87.1Co-12.9Hf film. The thickness of the sense layer structure 228 is selected in order to attain a saturation moment of 0.42 memu/cm² (corresponding to that of a 6 nm thick ferromagnetic 80Ni-20Fe film sandwiched into two Cu films).

A typical insulation layer 202 in each side region is formed of a 3 nm thick nonmagnetic, amorphous Al₂O₃ film. A typical longitudinal bias stack 204 in each side region comprises a seed layer 232 formed of a 4 nm thick nonmagnetic Cr film, a longitudinal bias layer 234 formed of a 24 nm thick hard-magnetic 82Co-18Pt film, and a cap layer 236 formed of a 10 nm thick nonmagnetic Cr film. The thickness of the Co—Pt longitudinal layer 234 is selected in order to attain a M_{R}δ_{LB} of 2.1 memu/cm² (corresponding to that of a 30 nm thick ferromagnetic 80Ni-20Fe film sandwiched into two Cu films, or five times of the saturation moment of the sense layer 228).

In the fabrication process of the read head 200, the CPP TMR or GMR read sensor 201 is deposited on a wafer with a lower ferromagnetic shield 206 formed of a 1 μm thick ferromagnetic 80Ni-20Fe film in a sputtering system, and is annealed in a magnetic field of 50,000 Oe for 5 hours at 280° C. in a high-vacuum oven. The CPP TMR or GMR read sensor 201 is patterned in a photolithographic process to produce sensor front and rear edges, and then patterned again in another photographic process to produce sensor tails at the two side regions. The Al₂O₃ insulation layer 202, the Cr seed layer 232, the Co—Pt longitudinal bias layer 234, and the Cr cap layers 236 are then sequentially deposited into the two side regions. Then, the photoresist is removed and a chemical-mechanical-polishing process is performed. As can be seen in FIG. 2, the CPP TMR or GMR read sensor 201 is separated by the Al₂O₃ insulation layer 202 from the longitudinal bias stack 204. The CPP TMR or GMR read sensor 201, the Al₂O₃ insulation layer 202, and the longitudinal bias stack 204 are then covered by an upper ferromagnetic shield 208 also formed of a 1 μm thick ferromagnetic 80Ni-20Fe film, and by a gap formed of a 1 μm thick ferromagnetic Al₂O₃ film. After completing the read head fabrication process, the write head fabrication process starts.

The Al₂O₃ insulation layer 202 must uniformly cover the tail of the CPP read sensor 201 in each side region and be thick enough to ensure full electrical isolation between the CPP read sensor 201 and the Co—Pt longitudinal bias stack 204. On the other hand, the Al₂O₃ insulation layer 204 must be also thin enough to minimize a spacing between the CPP read sensor 201 and the Co—Pt longitudinal bias stack 204, in order to enhance magnetostatic interactions between the CPP read sensor 201 and the Co—Pt longitudinal bias stack 204. With an optimal thickness of about 3 nm, the Al₂O₃ insulation layer 202 can fully confine the sense current in the CPP read sensor 201, and facilitate the Co—Pt longitudinal bias layer 234 to stabilize the sense layer structure 228.

The Cr seed layer 232 must uniformly cover the tail of the CPP read sensor 201 in each side region and be thick enough to ensure the free growth of its polycrystalline grains with body-centered-cubic (bcc) {011} planes lying in parallel to an interface between the Al₂O₃ insulation layer 202 and the Cr seed layer 232. This preferred crystalline texture will facilitate polycrystalline grains of the Co—Pt longitudinal bias layer 234 to grow with hexagonal-cubic-packed (hcp) {0110} or {0111} planes lying in parallel to an interface between the Cr seed layer 232 and the Co—Pt longitudinal bias layers 234, thereby orienting its c-axis (the easy axis of magnetization) to lie nearly in the interface and improving its in-plane hard-magnetic properties such as M_{R} and H_{C}. On the other hand, the Cr seed layer 232 must be also thin enough to minimize a spacing between the CPP read sensor 201 and the Co—Pt longitudinal bias layer 234, in order to enhance magnetostatic interactions between the CPP read sensor 201 and the Co—Pt longitudinal bias layer 234. With an optimal thickness of about 4 nm, the Cr seed layer 232 can improve the in-plane hard-magnetic properties of the Co—Pt longitudinal bias layer 234, and facilitate the Co—Pt longitudinal bias layer 234 to stabilize the sense layer structure 228.

In addition to high M_{R}δ_{LB} and high H_{C} needed for stabilizing the sense layer structure 214, the Co—Pt longitudinal bias layer 234 must uniformly cover the tail of the CPP read sensor 201 in each side region and be thick enough to provide M_{R} δ_{LB} high enough to eliminate side reading caused by the reversals of the magnetization of the sense layer structure 214. On the other hand, the longitudinal bias layer 234 must be also thin enough to provide M_{R} δ_{LB} low enough to attain high read sensitivity. With an optimal thickness of about 24 nm, the longitudinal bias layer 234 exhibits M_{R} δ_{LB} of 2.1 memu/cm² (corresponding to that of a 30 nm thick ferromagnetic 80Ni-20Fe film sandwiched into two Cu films, or five times of the saturation moment of the sense layer 228), and thus stabilize the sense layer structure 214 while maintaining high read sensitivity.

However, the total thickness of the insulation layer 202 and the longitudinal bias stack 204 (41 nm) is much larger than the thickness of the CPP read sensor 201 (27.3 nm), and thus a topography, on which the upper ferromagnetic shield 208 will be deposited, will be too steep. This steep topography will decrease read resolution. Therefore, it is crucial to minimize the optimal thicknesses of the insulation layer 202, the seed layer 232, and the longitudinal bias layer 234. Particularly for the longitudinal bias layer 234, since M_{R} δ_{LB} must remain unchanged, δ_{LB} can be minimized only by maximizing M_{R}. Since M_{R}═S M_{S}, where S is a squareness and M_{S} is a saturation magnetization, M_{R} can be maximized by maximizing S or M_{S}.

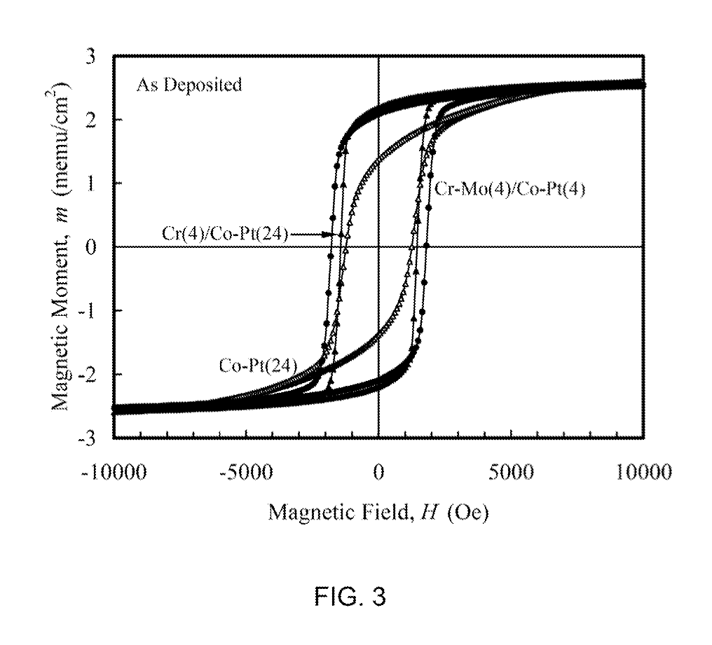

FIG. 3 shows easy-axis magnetic responses of as-deposited 82Co-18Pt(24)/Cr(10), Cr(4)/82Co-18Pt(24)/Cr(10) and 80Cr-20Mo(4)/82Co-18Pt(24)/Cr(10) films (thickness in nm) in accordance with a prior art. Without any seed layers, the Co—Pt longitudinal bias layer 234 exhibits Sofas low as 0.52, M_{S} of as high as 1,084 memu/cm³ in comparison with that of the ferromagnetic 80Ni-20Fe film (700 memu/cm³), and H_{C} of as high as 1,241 Oe. The low S, which originates from that the c-axis of the Co—Pt longitudinal bias layer 234 is oriented in a direction perpendicular to the interface between the Al₂O₃ insulation layer 202 and the Co—Pt longitudinal bias layer 234, leads to M_{R} δ_{LB} of as low as 1.37 memu/cm². On the other hand, with the Cr and Cr—Mo seed layers 232, the Co—Pt longitudinal bias layers 234 exhibit Sofas high as 0.84 and 0.82, respectively, and H_{C} of as high as 1,438 and 1,795 Oe, respectively. The high S, which originates from that the c-axis of the Co—Pt longitudinal bias layer 234 is oriented in a direction nearly parallel to the interface between the Cr seed layer 232 and the Co—Pt longitudinal bias layer 234, leads to M_{R} δ_{LB} of as high as around 2.1 memu/cm². On the other hand, the high H_{C} also originates from the preferred crystalline texture. In addition, a further increase in H_{C}, caused by adding Mo into Cr atoms originates from an improvement in lattice matching between the Cr—Mo seed layer 232 and Co—Pt longitudinal bias layer 234.

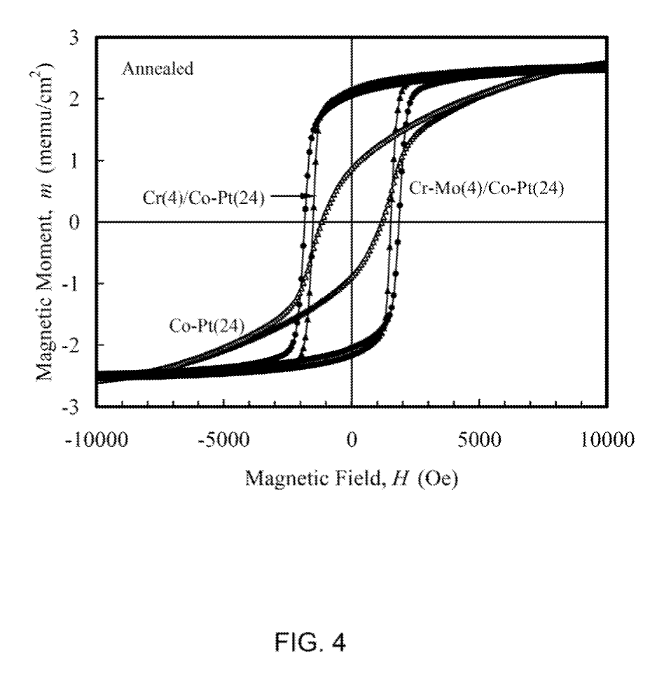

FIG. 4 shows easy-axis magnetic responses of 82Co-18Pt(24)/Cr(10), Cr(4)/82Co-18Pt(24)/Cr(10) and 80Cr-20Mo(4)/82Co-18Pt(24)/Cr(10) films after annealing for 5 hours at 280° C. in accordance with the prior art. Without any seed layers, the Co—Pt longitudinal bias layer 234 exhibits Sofas low as 0.33 and H_{C} of as high as 1,177 Oe. With the Cr and Cr—Mo seed layers 232, the Co—Pt longitudinal bias layers 234 exhibit S of as high as 0.84 and 0.82, respectively, and H_{C} of as high as 1,521 and 1,841 Oe, respectively. Therefore, after the annealing, S and H_{C} are slightly decreased when no any seed layers are used, but slightly increases when the Cr and Cr—Mo seed layers 232 are used.

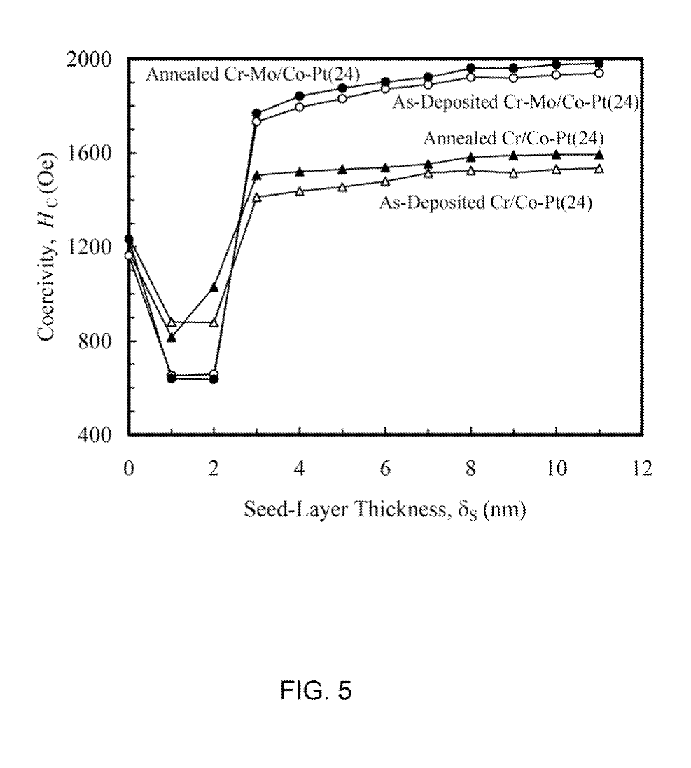

FIG. 5 shows H_{C} versus the seed layer thickness (δ_{S}) for the Cr/82Co-18Pt(24)/Cr(10) and 80Cr-20Mo/82Co-18Pt(24)/Cr(10) films before and after annealing for 5 hours at 280° C. in accordance with the prior art. For both as-deposited and annealed Cr/Co—Pt/Cr films, H_{C} decreases from around 1,200 to around 880 Oe as the thickness of the Cr seed layer 232 increases from 0 to 2 nm, and then increases to beyond 1,400 Oe as that increase to beyond 3 nm. For both as-deposited and annealed Cr—Mo/Co—Pt/Cr films, H_{C} decreases from around 1,200 to around 660 Oe as the thickness of the Cr—Mo seed layer 232 increases from 0 to 2 nm, and then increases to beyond 1,700 Oe as that increase to beyond 3 nm. FIG. 5 thus indicates that effects of the Cr and Cr—Mo seed layers 232 on H_{C} are much more significant than effects of annealing, and are attractive only when the Cr and Cr—Mo seed layers 232 are thick enough to fully develop the preferred crystalline texture.

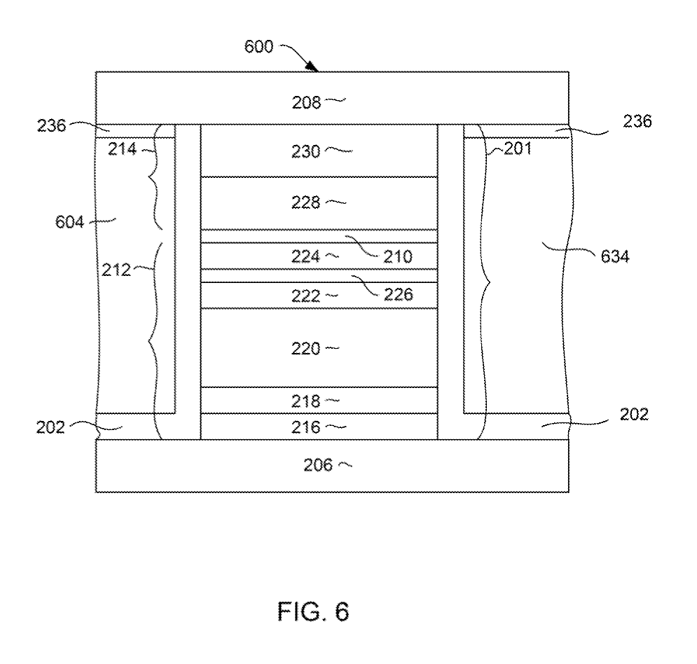

FIG. 6 shows a read head 600 in accordance with a preferred embodiment of the invention, in which an improved longitudinal bias stack 604 in each side region is proposed. In the read head 600, a CPP TMR or GMR read sensor 201, that is identical to or smaller than that described in FIG. 2, is electrically insulated by insulation layers 202 from the longitudinal bias stacks 604 in two side regions for preventing a sense current from shunting through the two side regions, but is electrically connected with the lower and upper ferromagnetic shields 206, 208 for allowing the sense current to flow in a direction perpendicular to planes of the CPP TMR or GMR read sensor 201.

The longitudinal bias stack 604 comprises a longitudinal bias layer 634 formed of a 20 nm thick hard-magnetic Fe—Pt film with a Pt content ranging from 44 to 50 at %, and a cap layer 636 formed of a 60 nm thick nonmagnetic Ru film. The thickness of the Fe—Pt longitudinal layer 634 is selected in order to attain M_{R} δ_{LB} of 1.68 memu/cm² (corresponding to that of a 24 nm thick ferromagnetic 80Ni-20Fe film sandwiched into two Cu films). By eliminating the seed layer 232, the thickness of the Al₂O₃ insulation layer 202 (3 nm) alone defines the spacing. Since the Fe—Pt longitudinal bias layer 634 without any seed layers exhibits H_{C} of as high as beyond 2,400 Oe after annealing, as described below, and the spacing becomes as narrow as 3 nm, the improved longitudinal bias stack 604 will be more effective in stabilizing the sense layer structure of the CPP read sensor 201 progressively miniaturized for magnetic recording at ever higher recording densities.

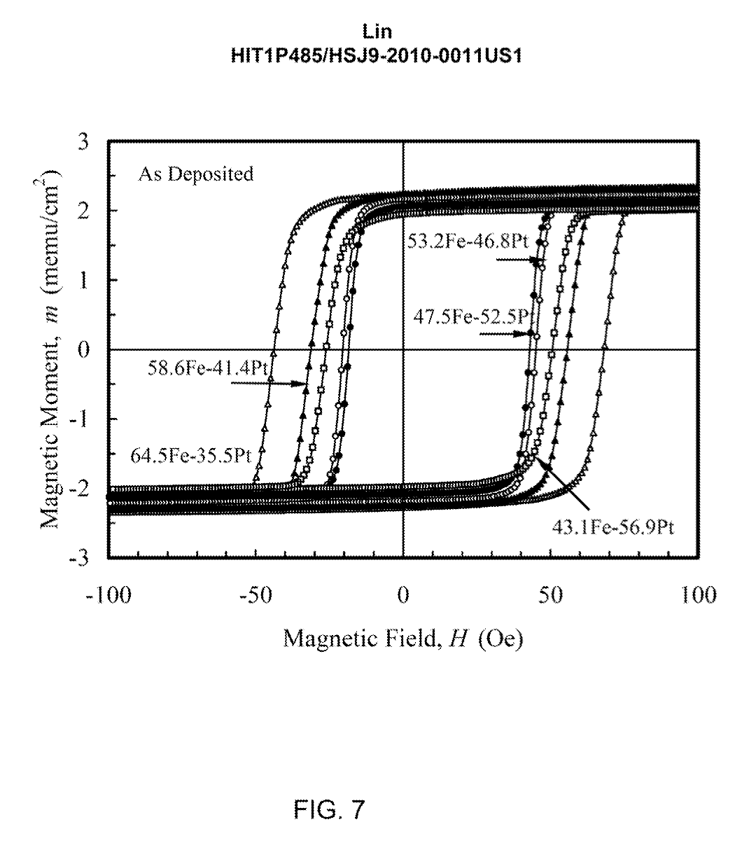

FIG. 7 shows easy-axis responses of as-deposited Fe—Pt(24) films. With Pt contents of 35.5, 41.4, 46.8, 52.5 and 56.9 at %, the Fe—Pt films exhibit H_{C} values of as low as 56.0, 43.5, 32.8, 30.7 and 38.4 Oe, respectively. Such low H_{C} values are too low to be used as the longitudinal bias layer 634 in the stabilization scheme.

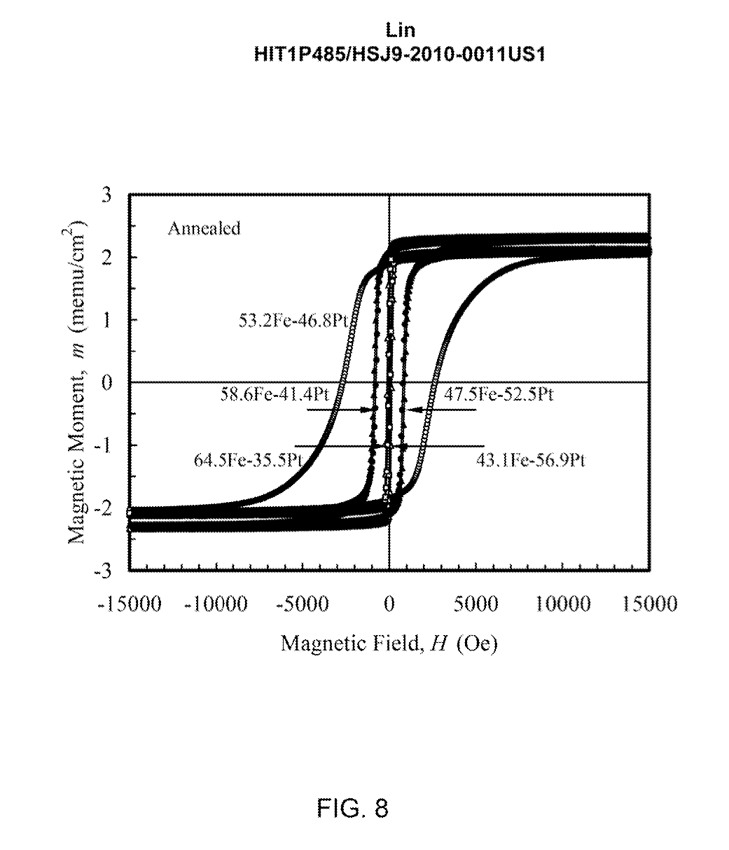

FIG. 8 shows easy-axis responses of Fe—Pt(24) films after annealing for 5 hours at 280° C. With Pt contents of 35.5, 41.4, 46.8, 52.5 and 56.9 at %, the Fe—Pt films exhibit H_{C} values of 140, 898, 2,687, 794 and 50 Oe, respectively. Only by selecting a Pt content of around 46.8 at % and utilizing annealing, H_{C} becomes substantially high enough for the stabilization scheme. In addition, after annealing the 53.2Fe-46.8Pt longitudinal bias layer 634, its S decreases from 0.96 to 0.91, and M_{S} decreases from 968 to 914 memu/cm³. The annealed 53.2Fe-46.8Pt longitudinal bias layer 634 thus exhibits high S, M_{S} and H_{C}, and can be used as the longitudinal bias layer 634 in the stabilization scheme. In addition, its required M_{R} δ_{LB} can be substantially reduced, since the spacing decreases from 7 to 3 nm after eliminating any seed layers, and H_{C} is substantially high.

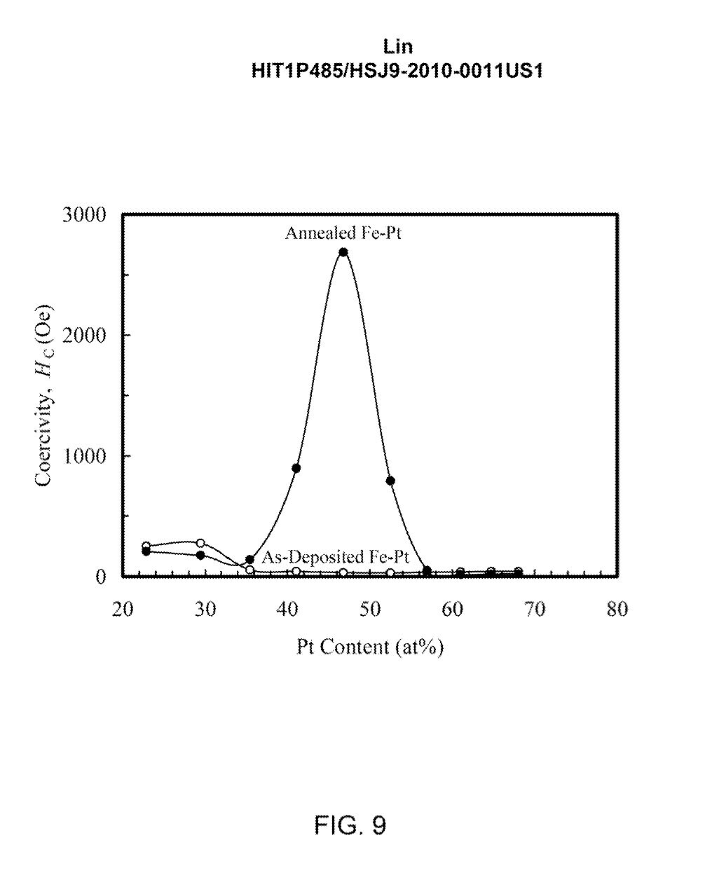

FIG. 9 shows H_{C} versus the Pt content for the Fe—Pt film before and after annealing for 5 hours at 280° C. Only when the Pt content is selected in a narrow range from 40 to 54 at %, effects of annealing on H_{C} becomes very significant.

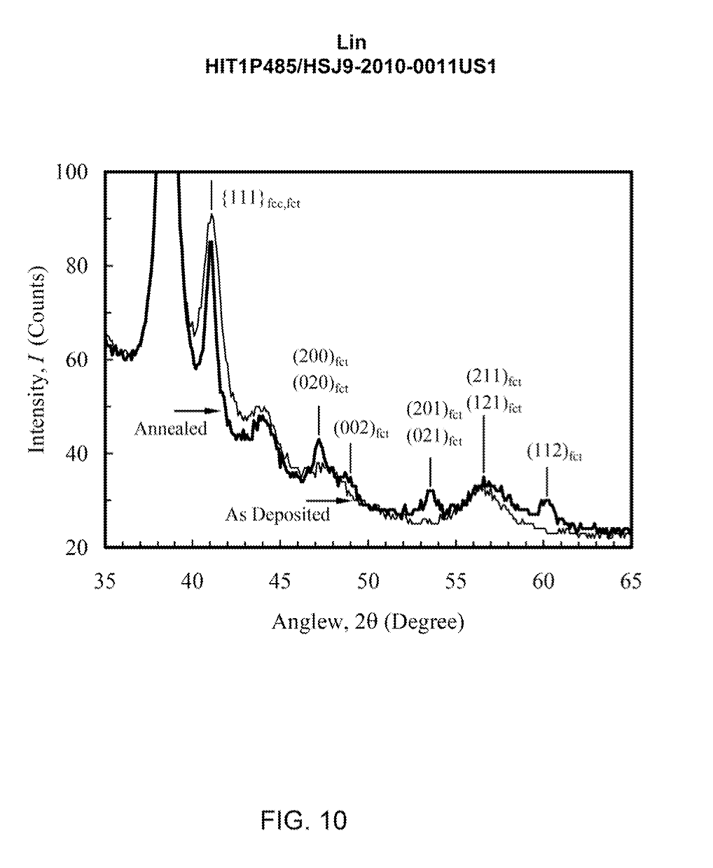

FIG. 10 shows x-ray diffraction patterns taken from the as-deposited and annealed 53.2Fe-46.8Pt films. A face-centered-cubic (fcc) phase with a strong {111}_{fcc} reflection and vague {200}_{fcc} and {211}_{fcc} reflections (a=0.3799 nm) are identified in the as-deposited Fe—Pt film. This fcc phase might be disordered so that the as-deposited Fe—Pt film exhibits low H_{C}. On the other hand, a face-centered-tetragonal (fct) phase with a strong {111}_{fcc} reflection, split {200}_{fct} and {211}_{fct} reflections, and newly appeared {201}_{fct} reflections (a=0.3847 nm, c=0.3714 nm and c/a=0.9654) are identified in the annealed Fe—Pt film. This fcc phase might be equiatomic and ordered so that the annealed Fe—Pt film exhibits very high H_{C}. Hence, the substantial H_{C} increase caused by the annealing might be associated with a transformation from the disordered fcc to fct phases only when the Fe and Pt contents are around 50 at %.

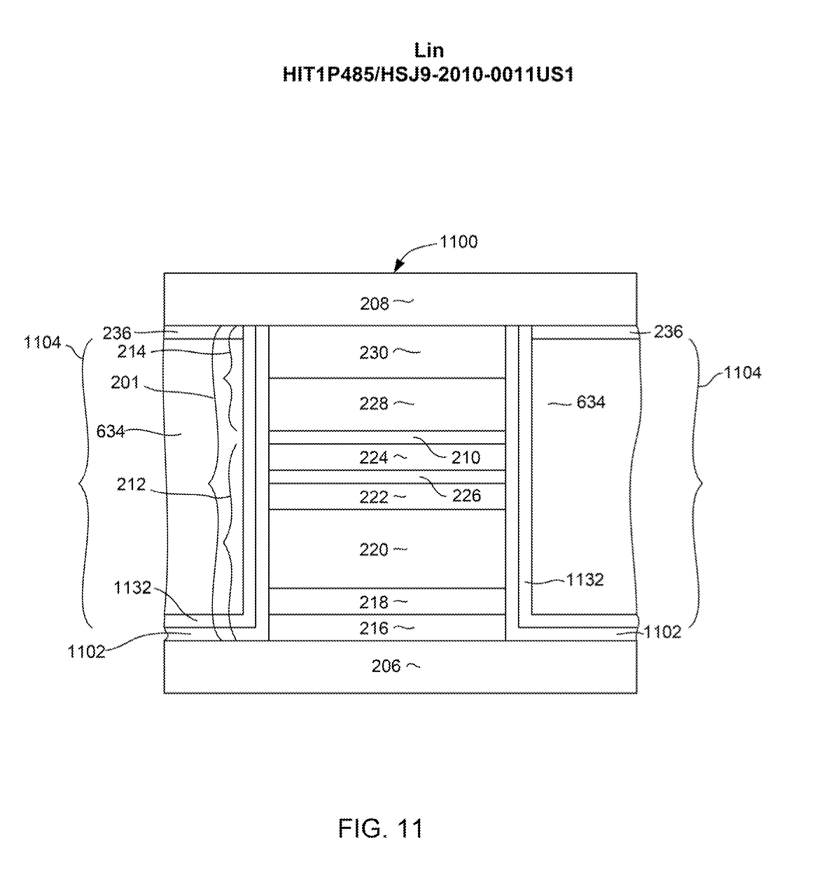

FIG. 11 shows a read head 1100 in accordance with an alternative embodiment of the invention, in which a further improved longitudinal bias stack 1104 in each side region is proposed. In the read head 1100, a CPP TMR or GMR read sensor 201, that is identical to or smaller than that described in FIG. 2, is electrically insulated by insulation layers 1102 from the longitudinal bias stacks 1104 in two side regions for preventing a sense current from shunting through the two side regions, but is electrically connected with the lower and upper ferromagnetic shields 206, 208 for allowing the sense current to flow in a direction perpendicular to planes of the CPP TMR or GMR read sensor 201.

The insulation layer 1102 is formed of a 1.4 nm thick nonmagnetic, amorphous Al₂O₃ film. The longitudinal bias stack 1104 comprises a insulating seed layer 1132 formed of a 1.6 nm thick nonmagnetic, polycrystalline MgO film, a longitudinal bias layer 634 formed of a 20 nm thick hard-magnetic Fe—Pt film with a Pt content ranging from 44 to 50 at %, and a cap layer 636 formed of a 60 nm thick nonmagnetic Ru film. The thickness of the Fe—Pt longitudinal layer is selected in order to attain M_{R} δ_{LB} 1.68 memu/cm² (corresponding to that of a 24 nm thick ferromagnetic 80Ni-20Fe film sandwiched into two Cu films). The MgO seed layer 1132 replaces a portion of the Al₂O₃ insulation layer 1102 and also acts as another insulation layer. As a result, the total thickness of the Al₂O₃ insulation layer 1102 and the MgO seed layer 1132 (3 nm) defines the spacing, and thus the spacing remains narrow. In addition, with an identical thickness, a spacing formed of two dissimilar oxide films generally exhibits a breakdown voltage (characterizing an insulating property) higher than that formed of an oxide film only, since the growth of pinholes in the lower oxide film during the deposition is interrupted at interfaces between the two dissimilar oxide films. Since the Fe—Pt longitudinal bias layer 634 with the MgO seed layer 1132 exhibits H_{C} as high as beyond 3,200 Oe after annealing, as described below, and the spacing remains as narrow as 3 nm, the further improved longitudinal bias stack 1104 is expected more effective in stabilizing the sense layer structure 228 of the CPP read sensor 201 progressively miniaturized for magnetic recording at ever higher recording densities.

In addition, in both the preferred and alternative embodiments of the invention, an additional conducting seed layer formed of a 1.8 nm thick nonmagnetic, polycrystalline Ru film can be used beneath the Fe—Pt longitudinal bias layer 634. While the spacing increases unwantedly by 1.8 nm, the Fe—Pt longitudinal bias layer 634 with the MgO seed layer 1106 and the additional Ru seed layer exhibits H_{C} of as high as beyond 4,000 Oe after annealing, as described below. Hence, although this approach violates the principle of minimizing the spacing in the invention, it is still acceptable and attractive due to the substantially high H_{C}.

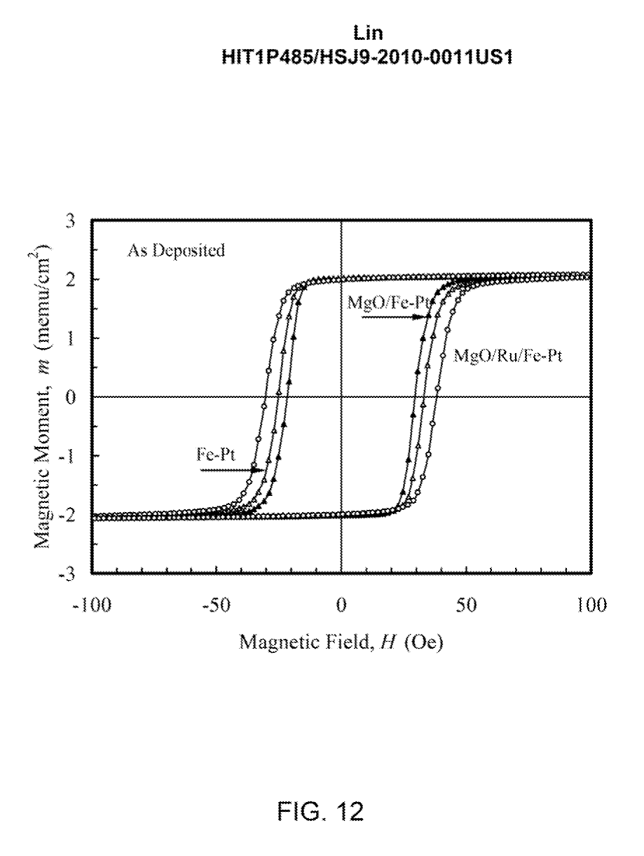

FIG. 12 shows easy-axis responses of as-deposited Fe—Pt(20), MgO(1.6)/Fe—Pt(20) and MgO(1.6)/Ru(1.8)/Fe—Pt(20) films. The uses of the MgO and MgO/Ru seed layers cause H_{C} variations from 29.1 to 25.5 and 34.2 Oe, respectively. Therefore, effects of the MgO and MgO/Ru seed layers on H_{C} of the as-deposited Fe—Pt film are not attractive at all. These low H_{C} values are too low to be used as the longitudinal bias layer 634 in the stabilization scheme.

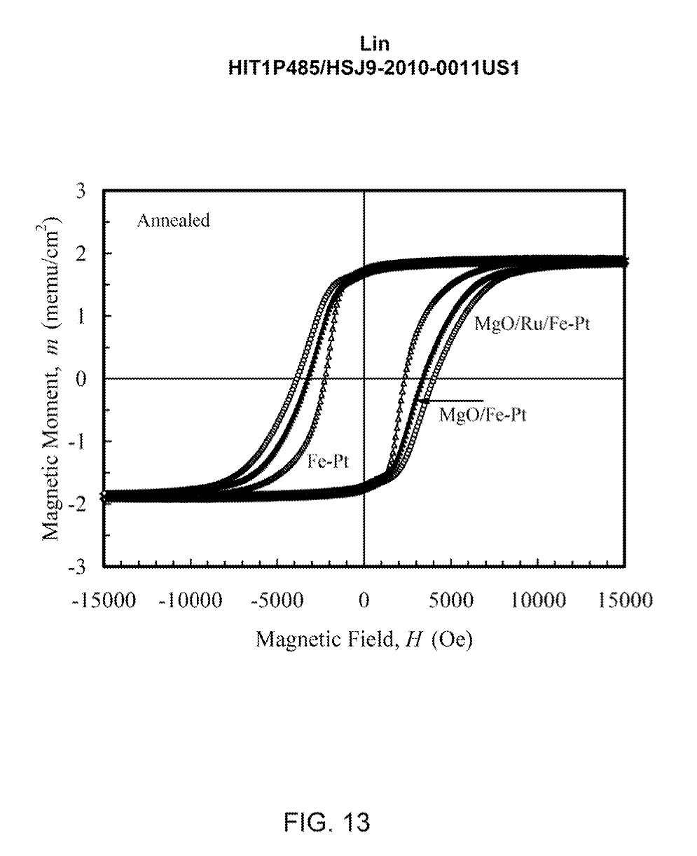

FIG. 13 shows easy-axis responses of Fe—Pt(20), MgO(1.6)/Fe—Pt(20) and MgO(1.6)/Ru(1.8)/Fe—Pt(20) films annealing for 5 hours at 280° C. The uses of the MgO and MgO/Ru seed layers cause H_{C} increases from 2,291 to 3,306 and 4,010 Oe, respectively. Therefore, not only effects of the annealing on H_{C} are very significant, but also effects of the MgO and MgO/Ru seed layers on H_{C} become also very significant after annealing. With these very high H_{C}, the annealed Fe—Pt film with the MgO and MgO/Ru seed layers can this be used as the longitudinal bias layer 634 in the stabilization scheme.

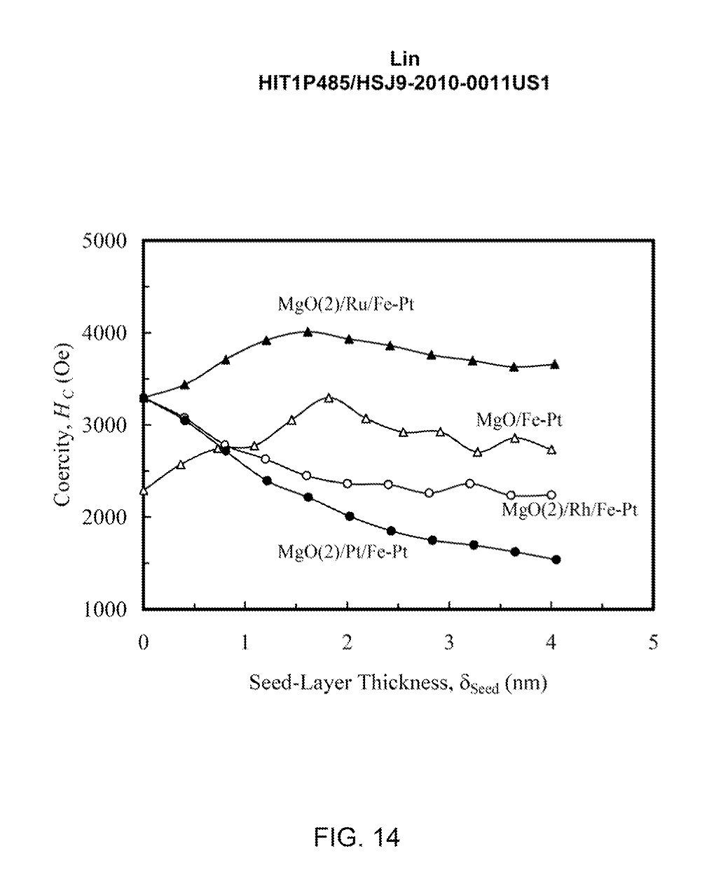

FIG. 14 shows H_{C} versus the seed-layer thickness for the Fe—Pt(20) films with MgO, MgO(1.6)/Ru, MgO(1.6)/Rh and MgO(1.6)/Pt seed layers. H_{C} increases as the MgO and Ru seed-layer thicknesses increases, but decreases as the Rh and Pt seed-layer thicknesses increase. The Ru seed layer thus appears the best among the three conducting seed layers, and more importantly, it only needs 1.8 nm in thickness, instead of beyond 3 nm in thickness in the prior art, to reach the maximal H_{C}.

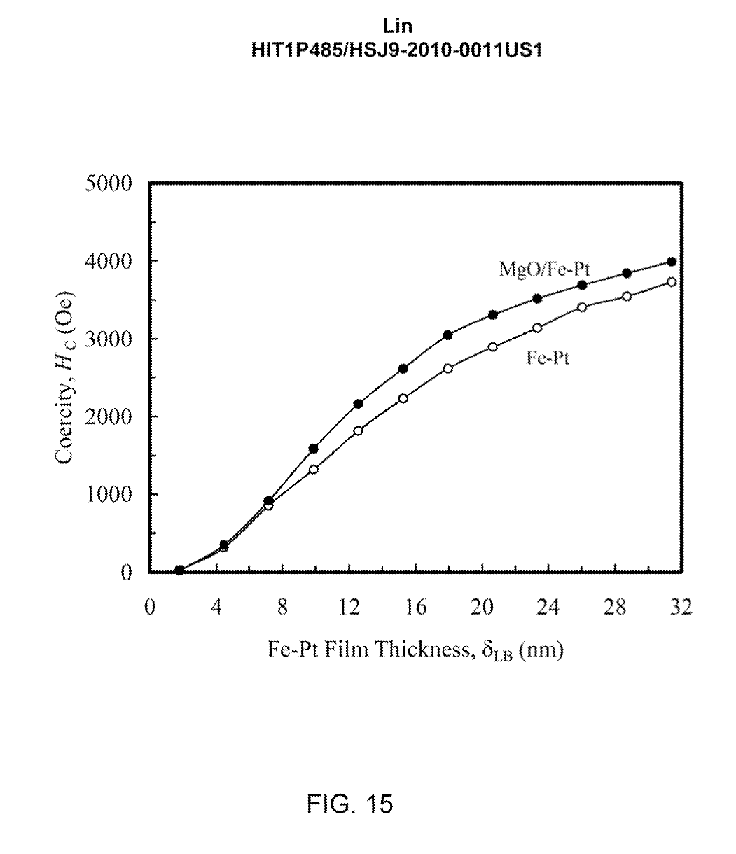

FIG. 15 shows H_{C} versus the Fe—Pt film thickness for Fe—Pt and MgO(1.6)/Fe—Pt films. In both cases, H_{C} increases as the Fe—Pt film thickness increases. To achieve H_{C} beyond 2,000 Oe, the Fe—Pt films without and with the MgO seed layer 1132 only need to exceed 12 nm and 14 nm in thickness, respectively. With such high H_{C}, the thin Fe—Pt films can be used as the longitudinal bias layers 634 to stabilize the sense layer structure 228 with a saturation moment of 0.28 memu/cm² (corresponding to that of a 4 nm thick ferromagnetic 80Ni-20Fe film sandwiched into two Cu films). In addition, a smooth topography can be expected.

It should be noted that the cap layer also plays an important role in achieving high H_{C}. Table 1 lists H_{C} values for the Fe—Pt films with various seed layers. H_{C} substantially increases as the Ru cap layer replaces a Ta cap layer. As a result, the cap layer formed of a nonmagnetic Ru film is proposed.

| Seed Layer | Ta Cap Layer | Ru Cap Layer |
|---|---|---|
| None | 2,069 | 2,291 |
| MgO(1.6) | 2,113 | 3,306 |
| MgO(1.6)/Pt(1.8) | 2,783 | 3,072 |
| MgO(1.6)/Rh(1.8) | 1,649 | 2,682 |
| MgO(1.6)/Ru(1.8) | 2,700 | 4,010 |

In addition, a method of activating the stabilization scheme is also proposed. After completing the read head fabrication process, the read head 600 is annealed in a magnetic field of 50,000 Oe perpendicular to sensor front and rear edges for 5 hours at 280° C. in a high-vacuum oven, and is then re-magnetized in a magnetic field of 50,000 Oe parallel to the sensor front and rear edges at room temperature. After the annealing and re-magnetization steps, the magnetizations of the keeper and reference layers 222, 224 of the CPP read sensor 201 are oriented in opposite directions perpendicular to sensor front and rear edges, while the magnetization of the Fe—Pt longitudinal bias layer 434 parallel to the sensor front and rear edges.

While various embodiments have been described, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A read head, comprising:
a current-perpendicular-to-plane (CPP) tunneling magnetoresistance (TMR) or giant magnetoresistance (GMR) read sensor sandwiched between lower and upper ferromagnetic shields, the read sensor having first and second sides;
an insulation layer on each of the first and second sides of the read sensor and on a portion of the lower ferromagnetic shield; and
a longitudinal bias layer on and contacting the insulation layer.

2. The read head as in claim 1 wherein the insulation layer is formed of a nonmagnetic, amorphous Al₂O₃ (alumina) film with a thickness ranging from 1 to 5 nm.

3. The read head as in claim 1 wherein the longitudinal bias layer is formed of a hard-magnetic, polycrystalline Fe—Pt film with a Pt content ranging from 40 to 54 at % and with a thickness ranging from 10 to 40 nm.

4. The read head as in claim 1 wherein the cap layer is formed of a nonmagnetic, polycrystalline Pt, Rh or Ru film with a thickness ranging from 1 to 10 nm.

5. A method of fabricating a read head, comprising:
forming a lower ferromagnetic shield;
depositing a CPP read sensor on the lower ferromagnetic shield;
forming a front edge and a back edge on the CPP read sensor
forming first and second sides of the CPP read sensor in two side regions;
depositing an insulation layer on the first and second sides of the CPP read sensor and on a portion of the lower ferromagnetic shield;
depositing a longitudinal bias layer formed of a hard-magnetic Fe—Pt film on the insulation layer; and
forming an upper ferromagnetic shield.

6. The method as in claim 5 further comprising:
annealing the read head in a magnetic field of 50,000 Oe perpendicular to the front and rear edges of the CPP read sensor for 5 hours at 280° C. in a high-vacuum oven; and
re-magnetizing the read head in a magnetic field of 50,000 Oe parallel to the front and rear edges of the CPP read sensor.

7. A read head comprising:
a current-perpendicular-to-plane (CPP) read sensor sandwiched between lower and upper ferromagnetic shields, the CPP read sensor having first and second sides;
an insulation layer on each of the first and second sides of the CPP read sensor and on a portion of the lower ferromagnetic shield; and
a longitudinal bias stack comprising
a seed layer on the insulation layer;
a longitudinal bias layer comprising Fe—Pt on the seed layer; and
a cap layer on the longitudinal bias layer.

8. The read head as in claim 7 wherein the insulation layer is formed of a nonmagnetic, amorphous Al₂O₃ (alumina) film with a thickness ranging from 1 to 5 nm.

9. The read head as in claim 7 wherein the conducting seed layer is formed of a nonmagnetic, polycrystalline Ru film with a thickness ranging from 1 to 4 nm.

10. The read head as in claim 7 wherein the longitudinal bias layer is formed of a hard-magnetic, polycrystalline Fe—Pt film with a Pt content ranging from 40 to 54 at % and with a thickness ranging from 10 to 40 nm.

11. The read head as in claim 7 wherein the cap layer is formed of a nonmagnetic, polycrystalline Pt, Rh or Ru film with a thickness ranging from 1 to 10 nm.

12. A method of fabricating a read head, comprising:
forming a lower ferromagnetic shield;
depositing a read sensor on the lower ferromagnetic shield;
forming front and back edges of the CPP read sensor;
forming first and second sides of the CPP read sensor in two side regions;
depositing an insulation layer on the first and second sides of the CPP read sensor and on a portion of the lower ferromagnetic shield;
depositing a seed layer formed of a nonmagnetic, polycrystalline Ru film on the insulation layer;
depositing a longitudinal bias layer formed of a hard-magnetic Fe—Pt film on the seed layer;
depositing a cap layer formed of a nonmagnetic Pt, Rh or Ru film on the longitudinal bias layer; and
forming an upper ferromagnetic shield.

13. The method as in claim 12, further comprising:
annealing the read head in a magnetic field of 50,000 Oe perpendicular to the front and back edges of the CPP read sensor for 5 hours at 280° C. in a high-vacuum oven; and
re-magnetizing the read head in a magnetic field of 50,000 Oe parallel to the front and rear edges of the CPP read sensor.

14. A read head, comprising:
a current-perpendicular-to-plane (CPP) read sensor sandwiched between lower and upper ferromagnetic shields, the CPP read sensor having first and second sides;
an insulation layer on each of the first and second sides of the CPP read sensor and on a portion of the lower ferromagnetic shield; and
a longitudinal bias stack comprising
an electrically insulating seed layer on the insulation layer;
a longitudinal bias layer on the electrically insulating seed layer; and
a cap layer on the longitudinal bias layer.

15. The read head as in claim 14 wherein the insulation layer is formed of a nonmagnetic, amorphous Al₂O₃ (alumina) film with a thickness ranging from 1 to 5 nm.

16. The read head as in claim 14 wherein the electrically insulating seed layer is formed of a nonmagnetic, polycrystalline MgO film with a thickness ranging from 1 to 4 nm.

17. The read head as in claim 14 wherein the longitudinal bias layer is formed of a hard-magnetic, polycrystalline Fe—Pt film with a Pt content ranging from 40 to 54 at % and with a thickness ranging from 10 to 40 nm.

18. The read head as in claim 14 wherein the cap layer is formed of a nonmagnetic, polycrystalline Pt, Rh or Ru film with a thickness ranging from 1 to 10 nm.

19. A method of fabricating a read head, comprising:
forming a lower ferromagnetic shield;
depositing a CPP read sensor on the lower ferromagnetic shield;
forming front and back edges of the CPP read sensor;
forming first and second sides of the CPP read sensor in two side regions;
depositing an insulation layer on the first and second sides of the CPP read sensor and on a portion of the lower ferromagnetic shield;
depositing an electrically insulating seed layer formed of a nonmagnetic, polycrystalline MgO film on the insulation layer;
depositing a longitudinal bias layer formed of a hard-magnetic Fe—Pt film on the electrically insulating seed layer;
depositing a cap layer formed of a nonmagnetic Pt, Rh or Ru film on the longitudinal bias layer; and
forming an upper ferromagnetic shield.

20. The method as in claim 19, further comprising:
annealing the read head in a magnetic field of 50,000 Oe perpendicular to the front and back edges of the CPP read sensor for 5 hours at 280° C. in a high-vacuum oven; and
re-magnetizing the read head in a magnetic field of 50,000 Oe parallel to the front and back edges of the CPP read sensor.

21. A read head, comprising:
a current-perpendicular-to-plan (CPP) read sensor sandwiched between lower and upper ferromagnetic shields, the CPP read sensor having first and second sides;
an insulation layer on each of the first and second sides of the CPP read sensor and on a portion of the lower ferromagnetic shield; and
a longitudinal bias stack comprising
an electrically insulating seed layer on the insulation layer;
an electrically conducting seed layer on the electrically insulating seed layer;
a longitudinal bias layer on the electrically conducting seed layer; and
a cap layer on the longitudinal bias layer.

22. The read head as in claim 21 wherein the insulation layer is formed of a nonmagnetic, amorphous Al₂O₃ (alumina) film with a thickness ranging from 1 to 5 nm.

23. The read head as in claim 21 wherein the insulating seed layer is formed of a nonmagnetic, polycrystalline MgO film with a thickness ranging from 1 to 4 nm.

24. The read head as in claim 21 wherein the conducting seed layer is formed of a nonmagnetic, polycrystalline Ru film with a thickness ranging from 1 to 4 nm.

25. The read head as in claim 21 wherein the longitudinal bias layer is formed of a hard-magnetic, polycrystalline Fe—Pt film with a Pt content ranging from 40 to 54 at % and with a thickness ranging from 10 to 40 nm.

26. The read head as in claim 1 wherein the cap layer is formed of a nonmagnetic, polycrystalline Pt, Rh or Ru film with a thickness ranging from 1 to 10 nm.

27. A method of fabricating a read head, comprising:
forming a lower ferromagnetic shield;
depositing a CPP read sensor on the lower ferromagnetic shield;
forming front and back edges of the CPP read sensor;
forming first and second sides of the CPP read sensor in two side regions;
depositing an electrical insulation layer on the first and second sides of the CPP read sensor and on a portion of the lower ferromagnetic shield;
depositing an electrically insulating seed layer formed of a nonmagnetic, polycrystalline MgO film on the insulation layer;
depositing an electrically conducting seed layer formed of a nonmagnetic, polycrystalline Ru film on the insulating seed layer;
depositing a longitudinal bias layer formed of a hard-magnetic Fe—Pt film on the conducting seed layer;
depositing a cap layer formed of a nonmagnetic Pt, Rh or Ru film on the longitudinal bias layer; and
forming an upper ferromagnetic shield.

28. The method as in claim 27, further comprising:
annealing the read head in a magnetic field of 50,000 Oe perpendicular to the front and rear edges of the CPP read sensor for 5 hours at 280° C. in a high-vacuum oven; and
re-magnetizing the read head in a magnetic field of 50,000 Oe parallel to the front and rear edges of the CPP read sensor.
